(19) United States
(12) Patent Application Publication
(10) Pub. No.: US 2025/0027334 A1
(43) Pub. Date: Jan. 23, 2025

(54) VEHICLE LOCK

(71) Applicant: INDULOCKS CERRADURAS INDUSTRIALES S.L., Madrid (ES)

(72) Inventor: Pedro TORAN POGGIO, Madrid (ES)

(21) Appl. No.: 18/781,419

(22) Filed: Jul. 23, 2024

(30) Foreign Application Priority Data
Jul. 23, 2023 (ES) 202331359

(51) Int. Cl. E05B 15/02; E05B 83/02; E05C 1/00; E05C 3/00

(52) U.S. Cl. CPC E05B 15/022; E05C 1/004; E05B 83/02; E05C 3/004

(57) ABSTRACT

A vehicle lock is provided for doors with a moving leaf. The vehicle lock includes a strike plate attached to a passive element, to which a bolt attached to the moving leaf is connected. One or more perpendicular spindles, along which the strike plate slides, emerge from the passive element.

### CROSS-REFERENCE TO RELATED APPLICATION

This application claims priority under 35 U.S.C. § 119 (a) to Spanish Patent Application No. 202331359, filed Jul. 23, 2023, the entire disclosure of which is incorporated herein by reference.

### TECHNOLOGY SECTOR

This invention refers to a lock, of the type generally used in van or truck containers, which offers improvements with regard to the reliability of the lock, as well as a reduction in wear and the effort required to lock the door.

### STATE OF THE TECHNOLOGY

There are currently various models in the industrial and commercial vehicle lock market. The security devices fitted to commercial and industrial vehicles are usually installed in the separation groove that the contact edge leaves between the moving leaf, which it is intended to secure, and a passive element, which will be the frame or the other leaf depending on whether it is a side or rear door.

Current inventions are designed on the basis that the passive element is aligned, coplanar with and at the same level as the door leaf. However, this is only the case when the vehicle is new. As a result of use, minor knocks and repairs, the gaps increase. Over time, what normally happens is that the leaf ends up a few millimetres or even centimetres away, breaking the coplanarity of the passive element.

Current solutions involve sliding a locking element (generally known as a “bolt”), which may or may not be spring loaded, and inserting it into a strike plate. The strike plate may be solid, with a cylindrical, elliptical bore, or a cylindrical or rod-type element may be installed in the passive element, with a groove along its edge, on which the bolt will rest or fit.

In other models, the bolt is rotated so as to enable the locking action to take place, with the strike plate being open on one side, where the bolt goes in. There are also strike plates in the form of a rod with a neck on which the bolt fits, either by means of a scissor mechanism or by sliding.

In these types of security devices, it is essential for the two leaves to be at the same level, as this directly affects the locking action and, consequently, both the security of the vehicle and its operation. Otherwise, if the opening or the neck of the strike plate is not in the right position for the locking action, the user will have to move or push the moving leaf in order to align them, which involves an effort and wear of the mechanisms. There could be a greater problem when opening the door, as a large force may need to be applied that ends up affecting the lock or the opening mechanism. For example, it could break or damage the key or affect the motor that moves the bolt, which would be overloaded.

The misalignment may also be caused by wear of the rubber door seal, which changes in size as a result of continuous use. Whether the door is new or has been in use for a number of years, the positions of the moving leaf and the passive element (frame or second leaf) will vary.

The applicant is not aware of any other solution that is similar to the invention.

### BRIEF EXPLANATION OF THE INVENTION

The invention consists of a vehicle lock as described in the claims.

The invention not only reduces the friction between the bolt and the strike plate, but also increases the space available to perform the locking function. Consequently, it also makes the lock easier to use, as the necessary torque or force is reduced.

The vehicle lock is designed for doors with at least one moving leaf, either hinged or sliding. The lock has a strike plate attached to a passive element. A bolt attached to the moving leaf is connected to this strike plate. The passive element consists of one or more spindles (generally cylindrical rods that stick out from the passive element), parallel with each other when there is more than one, along which the strike plate slides in order to face the bolt. In other words, the spindles act as a guide for the strike plate. This sliding motion creates the play or gap around the strike plate, which enables any coplanarity error to be assimilated. For this purpose, the spindles are largely perpendicular to the surface of the passive element. The spindles perform the function of installation of the strike plate and act as a guide for its adjustment movement. They may be threaded, preferably only on the part which is inserted into the passive element. As they are inserted into the passive element to a greater or lesser extent, it is possible to define the maximum sliding or adjustment movement of the strike plate.

The spindles will ideally be attached to a metal sheet (which may be considered part of the strike plate), which is in turn fixed to the passive element. This makes the resistance of the joint higher, and the security of the locking mechanism is also increased.

In order to guarantee that the strike plate is in exactly the right position, at least one spindle will include a spring to push the strike plate against the passive element.

Any positional adjustment should preferably be automatic and smooth. For this purpose, the lock may include an inclined plane in the area of contact between the bolt and the strike plate on the part furthest from the passive element. It should be understood that the inclined plane (with regard to the longitudinal part of the bolt) may be in the bolt, in the strike plate or in both. It is also possible to add another inclined plane in the part nearest the passive element. This will ensure a perfect fit.

It should be considered that the strike plate will generally be made up of two parts, in such a way that only one part moves along the spindles, while the other remains attached to the passive element. This improves the fixing, which may be carried out on the whole surface instead of only on the spindles. In this situation, the spindles may be attached to the fixed part of the strike plate instead of directly to the passive element.

The strike plate may be closed, open at both ends. . . . The strike plate may also be a solid element, without any holes, which is held in place by the bolt. In this case, it is the bolt that keeps the strike plate in the locked position.

Other embodiments are shown in the rest of the report.

### DESCRIPTION OF THE DIAGRAMS

For a better understanding of the invention, the following figures are included:

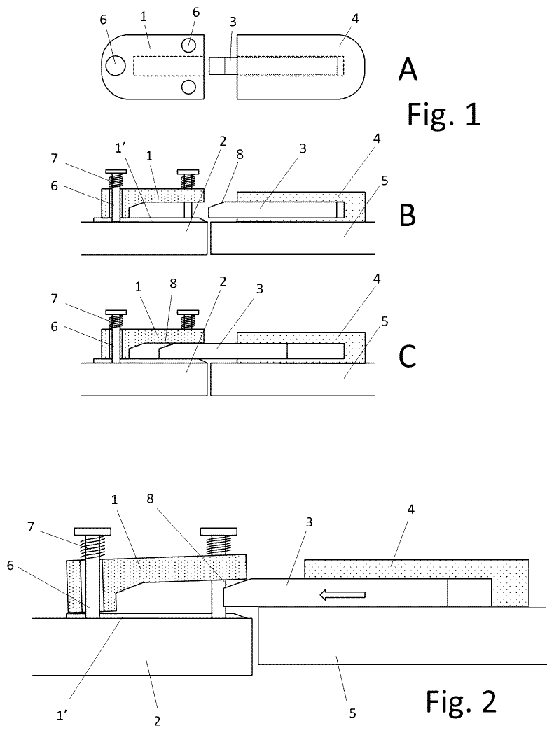

FIG. 1: Shows three schematic views of two locked positions of an embodiment: A) open front view, B) open longitudinal section, C) closed longitudinal section.

FIG. 2: Shows a fourth view of the embodiment example, where the moving leaf is not coplanar with the passive element.

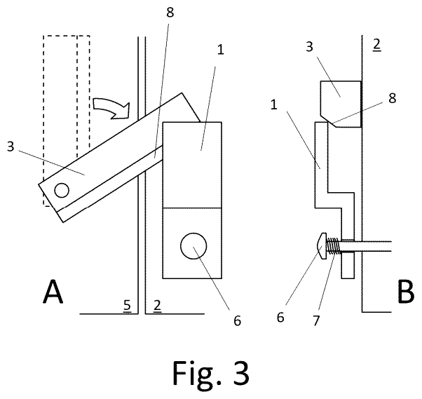

FIG. 3: Shows a second embodiment example, where there is a rotating locking movement: A) front view, B) side view.

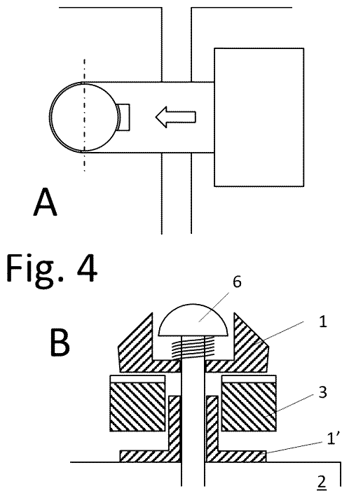

FIG. 4: Shows a third embodiment example, where the bolt holds the strike plate in place: A) half-closed front view, B) section based on the dotted line shown in view A.

### METHODS OF EMBODIMENT OF THE INVENTION

There follows a brief description of a method of embodiment of the invention, for information purposes only.

In FIGS. 1A and 1B, the different positions of a lock are shown according to a particular embodiment. This includes a strike plate (1), which is attached to a passive element (2) such as the frame of an industrial or commercial vehicle. If it is a double-leaf door, the strike plate (1) is attached to the leaf that opens second, which is in turn securely fixed to the frame.

Alternatively, the lock in FIGS. 1-2 has a bolt (3), such as a latch, which slides along a locking body (4) attached to the moving leaf (5). The bolt (3) may be connected to a spring which pushes it towards one end of the locking body (4). The bolt (3) is connected to a controller so that the user can open the lock. Any known controller may be used, including electromechanical elements. The system may have a controller locking element, in the form of a lock, although this is not essential for the invention.

The bolt (3) may be moved by rotation or any other type of movement, without necessarily having to be a sliding movement. FIG. 3 shows an example of a lock with a rotating movement.

FIG. 4 shows an additional embodiment in which the bolt (3) has a groove which holds the strike plate (1), in this case a rod with a neck that fits into the groove. The bolt (3) shown is a sliding bolt, but in the invention a scissor mechanism may also be used to hold the strike plate (1). In this case, the strike plate (1) is made up of two parts, with only the part furthest from the passive element (2) sliding along the spindles (6). The other part is a fixed part (1′) attached to the passive element (2). As can be seen, this embodiment only requires one spindle (6).

As is made clear in FIGS. 2-4, the strike plate (1) is mounted on spindles (6), with enough play to allow the strike plate (1) to move along them, normally in a direction perpendicular to the surface of the passive element (2). A spring (7) in at least one spindle (6) pushes the strike plate (1) against the passive element (2). In FIG. 3 only, the strike plate (1) has not separated from a fixed part (1′) from where the spindles (6) and a moving part emerge.

The bolt (3) and strike plate (1) have an inclined plane (8) in the contact area. This inclined plane (8) may be on one or both elements. It is situated so that the area of contact between the bolt (3) and the strike plate (1) is on the part furthest from the passive element (2). If the moving leaf (5) is perfectly coplanar with the moving element (2), the bolt (3) will go straight into the space in the strike plate (1). However, if they are not coplanar, they will collide with each other in the area of the inclined plane (8). This causes the strike plate (1) to move along the spindles (6) as it is kept apart by the inclined plane (8), as can be seen in FIG. 2. Once it has been separated, the bolt (3) fits perfectly into the strike plate (1). The springs (7) ensure that this support does not move and that the strike plate (1) returns to its initial rest position when the door is open.

The inclined plane (8) may also be in the area of contact between the bolt (3) and the strike plate (1) on the part nearest the passive element (2). This solution is particularly useful if the spindles (6) have springs (7) to centre the strike plate (1). In other words, they have springs (7) on both sides of the strike plate (1), enabling movement in both directions to ensure that it stays centred. This solution allows for play in any direction. In

1. A vehicle lock for doors with a moving leaf (5), with a strike plate (1) attached to a passive element (2), to which a bolt (3) attached to the moving leaf (5) is connected, wherein one or more perpendicular spindles (6), along which the strike plate (1) slides, emerge from the passive element.

2. The vehicle lock, according to claim 1, wherein at least one spindle (6) includes a spring (7) to push the strike plate (6) against the passive element (2).

3. The vehicle lock, according to claim 1, wherein it consists of an inclined plane (8) in the area of contact between the bolt (3) and the strike plate (1) on the part furthest from the passive element (2).

4. The vehicle lock, according to claim 3, wherein it also consists of an inclined plane (8) in the area of contact between the bolt (3) and the strike plate (1) on the part nearest the passive element (2).

5. The vehicle lock, according to claim 2, wherein it consists of springs (7) in at least one spindle (6) on both sides of the strike plate (1).

6. The vehicle lock, according to claim 1, wherein the strike plate (1) has a fixed part (1′) attached to the passive element (2), and a moving part on the spindles (6).

7. The vehicle lock, according to claim 1, wherein the spindles (6) are attached to the fixed part (1′) of the strike plate (1).

8. The vehicle lock, according to claim 4, wherein it consists of springs (7) in at least one spindle (6) on both sides of the strike plate (1).
